(19) United States
(12) Patent Application Publication
(10) Pub. No.: US 2022/0302556 A1
(43) Pub. Date: Sep. 22, 2022

(54) IMPROVED LEAD ACID BATTERY SEPARATORS INCORPORATING CARBON, AND IMPROVED BATTERIES, SYSTEMS, VEHICLES, AND RELATED METHODS

(71) Applicant: Daramic, LLC, Charlotte, NC (US)

(72) Inventors: J. Kevin Whear, Utica, KY (US); Susmitha Appikatla, Owensboro, KY (US)

(21) Appl. No.: 17/639,347

(22) PCT Filed: Sep. 1, 2020
(86) PCT No.: PCT/US2020/048865

§ 371 Date: Mar. 1, 2022

Related U.S. Application Data
(60) Provisional application No. 62/895,232, filed on Sep. 3, 2019.

(51) Int. Cl. H01M 50/431; H01M 50/449

(52) U.S. Cl. CPC H01M 50/431; H01M 50/449; H01M 10/06

(57) ABSTRACT

An improved carbon for use in a lead acid battery is disclosed herein. Also disclosed, is a metal oxide or metal sulfate additive that may be used in conjunction with the improved carbon. Battery performance of lead acid batteries, particularly flooded lead acid batteries, is improved by the use of the improved carbon or the improved carbon and the metal oxide or metal sulfate additive. Improvements to one or more of cycle life, dynamic charge acceptance, and water loss are observed.

### FIELD

This application relates generally to an improved carbon for use in a lead acid battery, which results in an improved lead acid battery even compared to previous lead acid batteries incorporating different types of carbon. The batteries exhibit at least one of the following properties: improved cycle life, improved dynamic charge acceptance (DCA), reduced water loss or combinations thereof. The improved carbon may be provided on a support, including a polyethylene battery separator, an absorptive glass mat (AGM) separator, or the like. This application also relates to an additive that can even further improve at least one of the following properties: improved cycle life, improved dynamic charge acceptance (DCA), reduced water loss or combinations thereof. The additive may be provided with the improved carbon on a support, including a polyethylene battery separator, an absorptive glass mat (AGM), or the like.

### BACKGROUND

A battery separator is used to separate the battery's positive and negative electrodes or plates in order to prevent an electrical short. Such a battery separator is typically porous so that ions may pass therethrough between the positive and negative electrodes or plates. In lead acid storage batteries, such as automotive batteries and/or industrial batteries and/or deep cycle batteries, the battery separator is typically a porous polyethylene separator; in some cases, such a separator may include a backweb and a plurality of ribs standing on one or both sides of the backweb. See: Besenhard, J. O., Editor, Handbook of Battery Materials, Wiley-VCH Verlag GmbH, Weinheim, Germany (1999), Chapter 9, pp. 245-292. Some separators for automotive batteries are made in continuous lengths and rolled, subsequently folded, and sealed along the edges to form pouches or envelopes that receive the electrodes for the batteries. Certain separators for industrial (or traction or deep cycle storage) batteries are cut to a size about the same as an electrode plate (pieces or leaves).

The electrodes in a lead acid battery are often made up of a lead alloy having a relatively high antimony content. Batteries operating at a partial state of charge (“PSOC”) tend to lend themselves to acid stratification. In this condition, more acid is concentrated within the electrolyte at the bottom of the battery, and more water is concentrated in the electrolyte at the top of the battery. Lead becomes soluble in water and goes into solution. However, the lead precipitates in acid and forms a solid crystal. Therefore, acid stratification tends to lead to lead sulfate (PbSO₄) crystal formation that form dendrites. Even without acid stratification, acid may be depleted during discharge and allow lead to go into solution, and then precipitate into crystals as acid is restored during a charge cycle.

When these crystals build up to a large enough size, the dendrites can tear or burn a hole through the separator and form a conductive bridge to connect the negative electrode to the positive electrode, thus leading to a short. This can hamper voltage discharge, charge acceptance, or even lead to a catastrophic failure and render the battery non-functional. All of which compromise the performance and life of the battery.

For at least certain applications or batteries, there remains a need for improved separators providing for improved cycle life, reduced acid stratification, and/or reduced dendrite formation. More particularly, there remains a need for improved separators, and improved batteries (such as those operating at a partial state of charge) comprising an improved separator, which provides for enhancing battery life, reducing battery failure, improving oxidation stability, improving, maintaining, and/or lowering float current, improving end of charge (“EOC”) current, decreasing the current and/or voltage needed to charge and/or fully charge a deep cycle battery, minimizing internal electrical resistance increases, lowering electrical resistance, reducing antimony poisoning, reducing acid stratification, improving acid diffusion, and/or improving uniformity in lead acid batteries.

Incorporating carbon is known to do at least one of: provide for enhanced battery life; reduce battery failure; improve oxidation stability; improve, maintain, and/or lower float current; improve end of charge (“EOC”) current; decrease the current and/or voltage needed to charge and/or fully charge a deep cycle battery; minimize internal electrical resistance increases; lower electrical resistance; reduce antimony poisoning; reduce acid stratification; improve acid diffusion; and/or improve uniformity in lead acid batteries. See, for example, WO 2019/051159, which is assigned to Daramic, LLC and is incorporated by reference herein in its entirety.

An approach to improving charge acceptance is based on the formation of lead sulfate crystals. The relative speed of discharge will impact the size of the lead sulfate crystals, slow discharge allows time for large crystals to form while faster discharge creates many smaller crystals. The smaller the crystals the more surface area and the faster the time to charge or reduce the crystals back to lead. If small crystals are given enough time, they will form larger and more thermodynamically stable crystals.

In automobile applications we are not at liberty to dictate the speed of discharge, but we have the goal of keeping the lead sulfate crystals as small as possible. Therefore the industry has proposed addition of Carbon to the NAM as a primary means for improving charge acceptance. Many have hypothesized theories regarding the mechanism of carbons, which includes nucleation sites for the precipitating small lead sulfate crystals or that carbon forms conductive paths to electronically connect the sulfation layer with the grid. Here we will propose a variant solution.

One solution proposed by the industry is to add a relatively small percent of carbon to the negative active material (NAM). As an alternative, Daramic proposed to put the carbon only where it is needed. As the battery is discharged, the lead sulfate first forms on the outer layers of the plate. Therefore, this is where the carbon is most needed on the outer surface of the plate and the carbon which is buried deep in the active material is of little use when the discharge is relatively shallow.

Therefore, another approach is to deliver the carbon to the surface of the negative electrode so that it has intimate contact with the lead sulfate as it is formed. A method of delivery is to coat carbon on the side of the separator that is in direct contact with the negative electrode. Daramic has employed such a process to coat the separator with carbon.

Daramic developed a precise coating process, allowing a thin layer of carbon to be placed on the separator. This layer may be very thin. This very thin layer may be approximately 10 microns thick and may add approximately 11 grams of carbon to a square meter of separator. This layer of carbon may also be porous.

When the carbon is added via the separator, amounts far less than when added to the NAM may be added. With lower amount of carbon incorporated in the system, we expect the water loss to be lower. By taking the carbon out of the NAM we can avoid troubles of absorbing the expander and resultant loss in power. Further, it was found that adding carbon via the separator improves direct charge acceptance (DCA) and waterloss.

Further improvements in cycle life, charge acceptance, and water loss are desirable.

### SUMMARY

Described herein is a lead acid battery, including flooded lead acid batteries, exhibiting one or more of the following properties: improved cycle life, improved charge acceptance, and decreased waterloss. Particularly preferred are batteries that exhibit or come close to one or more of the Consortium of Battery Innovations (CBI) Targets for 2022. These include a PSOC Cycle life (17.5% DOD) of 2000 or more cycles, a DCA (A/Ah) of 2.0, and a water loss (g/Ah) less than 3.

Applicants have approached or exceeded these targets through at least the use of an improved carbon or the use of the improved carbon and a metal oxide and/or metal sulfate additive. The use of the improved carbon disclosed herein and the improved carbon and a metal oxide and/or metal sulfate additive results in better performance than prior carbons.

In one aspect, a lead acid battery comprising carbon is described. The carbon may be added to any component of the battery including onto a surface of a battery separator, in the electrolyte, or in the negative active material. In some preferred embodiments, the carbon is provided such that it can be in direct contact with a negative active material (NAM), a positive active material (PAM), or both a NAM and a PAM. Direct contact with the NAM is particularly preferred.

The carbon has one or more of the following properties: an oil absorption equal to or greater than 140 ml/100 g and equal to or less than 500 ml/100 g; a specific surface area of 30 to 3,000 m²/g, a specific surface area from 50 m²/g to 1,600 m²/g, or a specific surface area from 800 m²/g to 1600 m²/g; a treated surface; and high structure.

In some preferred embodiments, the carbon may have a specific surface area of 30 to 3,000 m²/g, a specific surface area from 50 m²/g to 1,600 m²/g, or a specific surface area from 800 m²/g to 1600 m²/g, and the surface of the carbon may be a treated surface.

The treatment of the carbon surface is not so limited, but in some preferred embodiments may result in the presence of oxygen-containing groups on the surface of the carbon.

In some preferred embodiments, the carbon may be a furnace black carbon.

In some preferred embodiments, the carbon is provided on an internal surface of a substrate, an external surface of a substrate, or both an internal and external surface of a substrate. The substrate may be a porous membrane, including a polyethylene separator, a woven, a non-woven, a pasting paper, a fibrous mat, an absorptive glass mat (AGM), or combinations thereof. The amount of carbon provided on the substrate surface (internal or external) may be an amount from 1 to 20 grams per square-meter of substrate surface.

In some preferred embodiments, carbon and a metal oxide may be added to the battery. In a particularly preferred embodiment, carbon and a metal oxide and/or metal sulfate may be provided on a substrate, including a polyethylene separator, a woven, a non-woven, a pasting paper, a fibrous mat, an absorptive glass mat (AGM), or combinations thereof. The metal oxide may include one or more of the following: zinc oxide, titanium oxide and dioxide, magnesium oxide, aluminum oxide, calcium oxide, nickel oxide, sodium oxide, lithium oxide, potassium oxide, copper oxide, silver oxide, or combinations thereof. In some preferred embodiments, the metal oxide and/or metal sulfate is provided on the substrate in an amount of 1 to 10 grams of metal oxide per square-meter of substrate or in an amount of 2 to 5 grams of metal oxide and/or metal sulfate per square-meter of substrate.

The lead acid battery described herein above may have one or more of the following properties: cycle life of 1300 cycles or more, 1400 cycles or more, 1500 cycles or more, 1600 cycles or more, 1700 cycles or more, 1800 cycles or more, 1900 cycles or more, or 2000 cycles or more when measured using the VW 17.5% PSoC Test; a dynamic charge acceptance equal to or above about 1.2 A/Ah, equal to or above 1.4 A/Ah, or equal to or above 1.6 A/Ah when measured using the VW DCA at 70% SOC after 510 PSoC Cycles; and a water loss when measured by the Modified SAE-J537 overcharging test is less than 5.0 g/Ah, less than 4.5 g/Ah, less than 4.0 g/Ah, less than 3.5 g/Ah, less than 3.0 g/Ah, or less than 2.5 g/Ah.

The lead acid battery may be any one of a flat-plate battery, a flooded lead acid battery, an enhanced flooded lead acid battery, a deep-cycle battery, an absorptive glass mat battery, a tubular battery, an inverter battery, a vehicle battery, a SLI battery, an ISS battery, an automobile battery, a truck battery, a motorcycle battery, an all-terrain vehicle battery, a forklift battery, a golf cart battery, a hybrid-electric vehicle battery, an electric vehicle battery, an e-rickshaw battery, an e-trike battery, or an e-bike battery.

In another aspect, a coated battery separator that comprises a porous substrate and a carbon-containing coating on an internal and/or external surface of the porous membrane is disclosed. The carbon of the carbon-containing coating may have one or more of the following properties: an oil absorption equal to or greater than 140 ml/100 g and equal to or less than 500 ml/100 g; a specific surface area of 30 to 3,000 m²/g, a specific surface area from 50 m²/g to 1,600 m²/g, or a specific surface area from 800 m²/g to 1600 m²/g; a treated surface; and high structure.

In some preferred embodiments, the carbon may have a specific surface area of 30 to 3,000 m²/g, a specific surface area from 50 m²/g to 1,600 m²/g, or a specific surface area from 800 m²/g to 1600 m²/g, and the surface of the carbon may be a treated surface.

The treatment of the carbon surface is not so limited, but in some preferred embodiments may result in the presence of oxygen-containing groups on the surface of the carbon.

In some preferred embodiments, the carbon may be a furnace black carbon.

In some embodiments, the carbon is provided on the surface of the porous substrate in an amount of 1 to 20 grams per square-meter of substrate surface.

In some particularly preferred embodiments, the carbon may be provided along with a metal oxide and/or metal sulfate onto an internal surface, an external surface, or an internal and external surface of the porous substrate. The metal oxide may comprise one or more of zinc oxide, titanium oxide, magnesium oxide, aluminum oxide, calcium oxide, nickel oxide, sodium oxide, copper oxide, potassium oxide, lithium oxide and silver oxide. The metal oxide and/or metal sulfate may be provided on the substrate surface in an amount of 1 to 10 grams of metal oxide per square-meter of membrane surface or in an amount of 2 to 5 grams of metal oxide per square-meter of substrate surface.

In some embodiments, the porous substrate may be polyethylene separator, an absorptive glass mat separator, a pasting paper, a woven, a nonwoven, a glass mat, or a fibrous mat.

In some embodiments, the porous substrate may be a ribbed separator. In some particularly preferred embodiments, the ribbed separator may comprise an acid-mixing rib profile.

### DESCRIPTION OF THE FIGURES

FIG. 1 depicts Industry Development Targets for Improving Flooded Batteries.

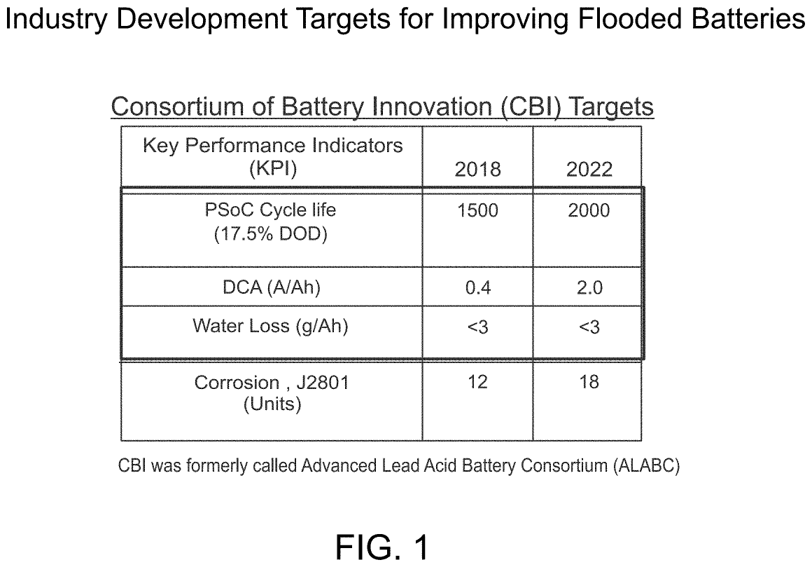

FIG. 2 depicts a proposed carbon mechanism and a prior industry solution of adding carbon to the negative active material (NAM).

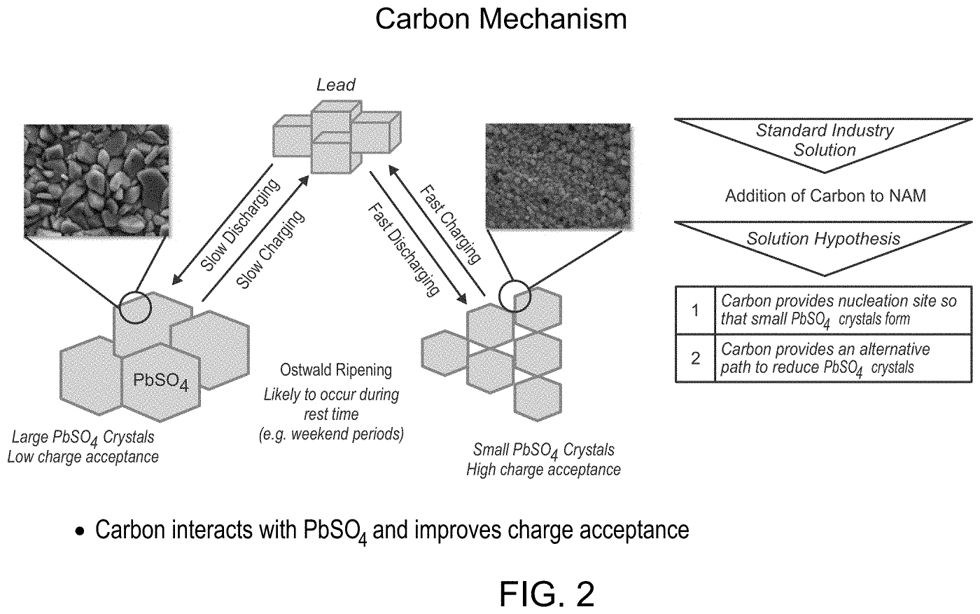

FIG. 3 depicts a past solution of adding carbon to the negative active material, and Daramic's solution of adding carbon to a separator.

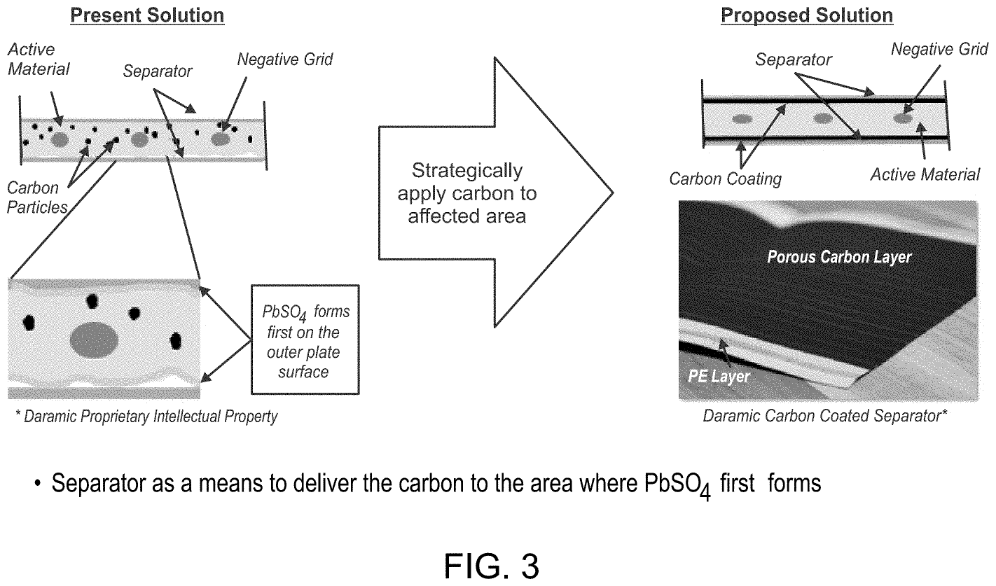

FIG. 4 depicts carbon coated separator properties and usage.

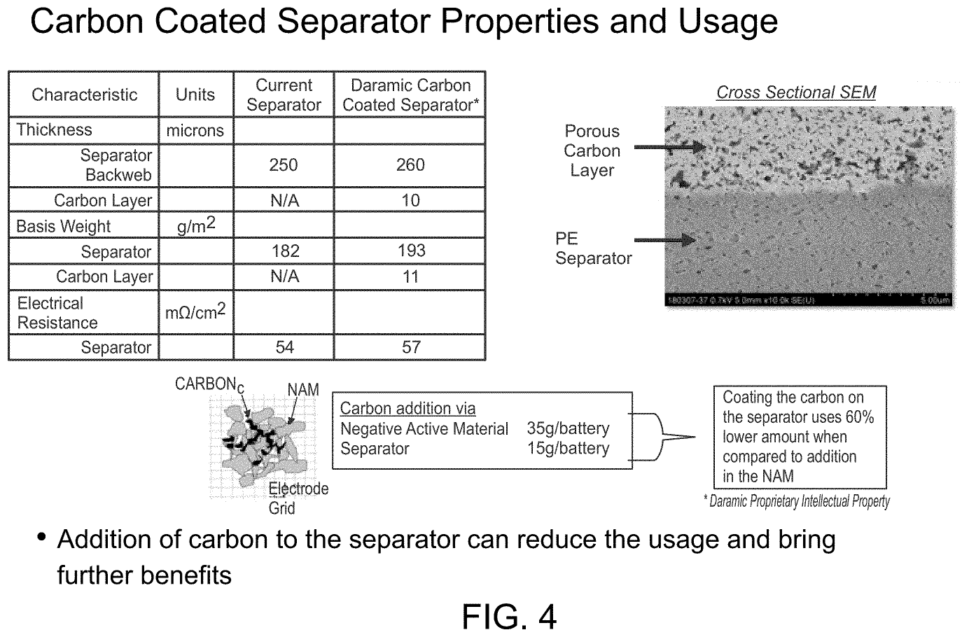

FIG. 5 depicts the effects of carbon v1 on properties such as cycle life and DCA.

FIG. 6 depicts the effects of Riptide®, which is an acid mixing profile, compared to Standard SLI, which is not. This is battery data.

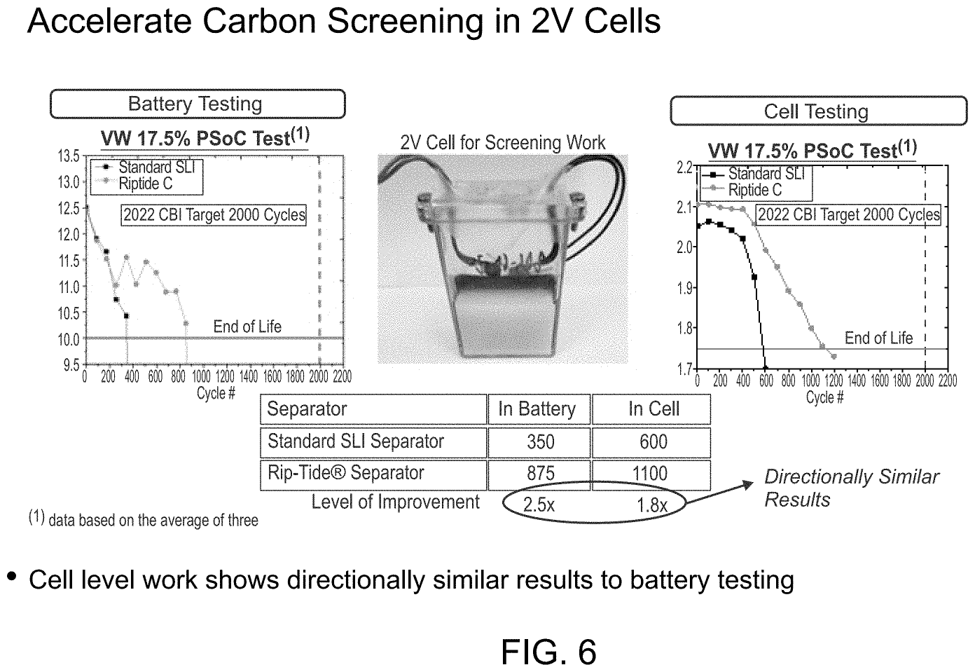

FIG. 7 depicts selection criteria for carbon v2 compared to carbon v1.

FIG. 8 depicts cycle life improvement and DCA improvement for carbon v2 compared to carbon v1.

FIG. 9 depicts waterloss measurements for embodiments described herein.

FIG. 10 depicts water loss measurements for embodiments described herein, including depicting improved water loss for embodiments using carbon v2 compared to embodiments using carbon v1.

FIG. 11 discloses types of oxidation treatment that may be used to form an improved carbon like carbon v2 as described herein.

FIG. 12 depicts an envelope made from Riptide® C.

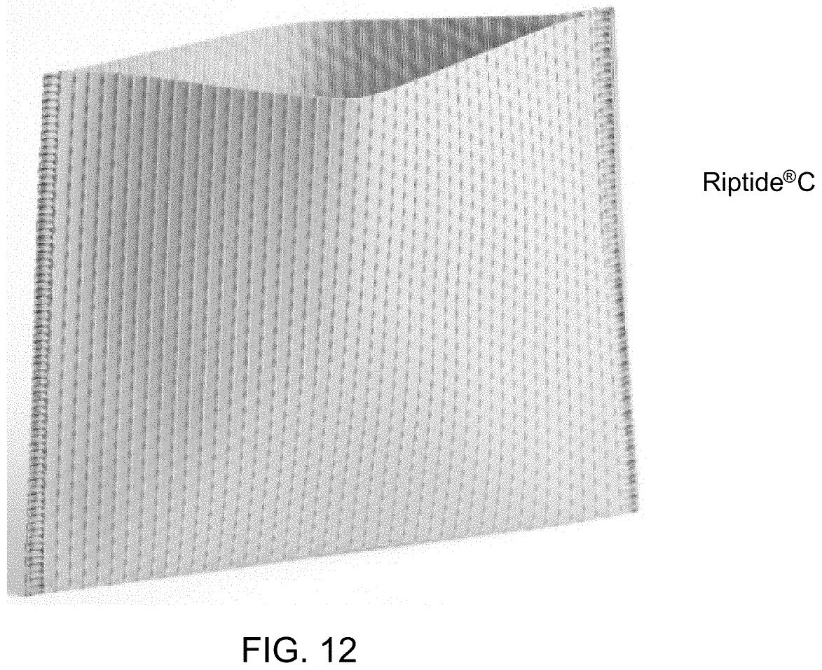

FIG. 13 is a schematic drawing of a compression resistant separator (Riptide® C) in a partial state of charge.

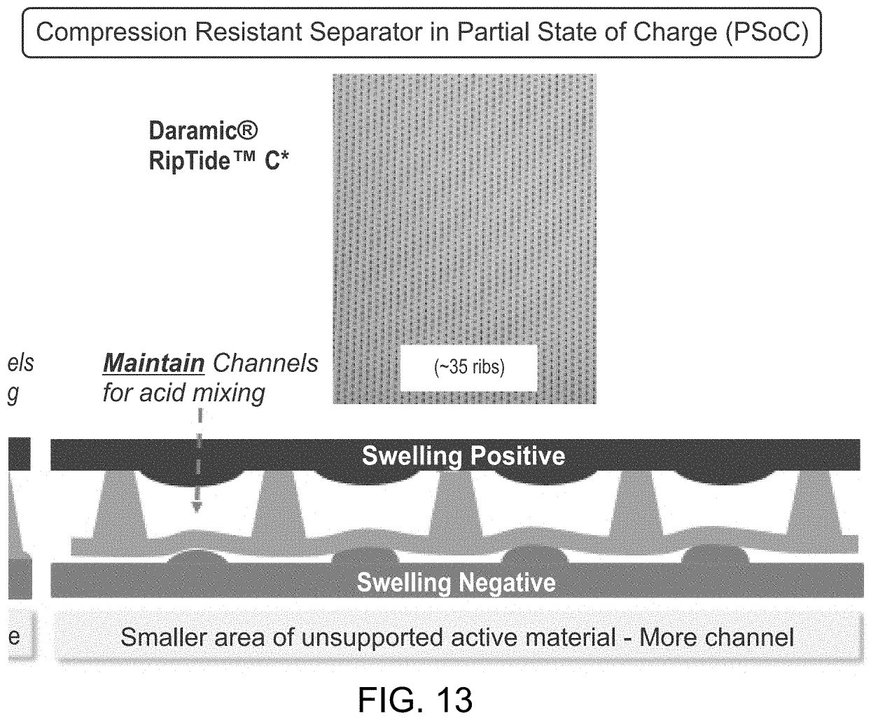

FIG. 14 depicts the effect of a metal oxide additive as described herein on cycle life.

FIG. 15 depicts water loss data for embodiments including carbon v2 with and without a metal oxide additive.

### DESCRIPTION

An improved carbon for use in a lead acid battery, including a flooded lead acid battery, is described herein. When the improved carbon is used in a lead acid battery, the battery exhibits at least one of longer cycle life, increased charge acceptance, and decreased waterloss compared to prior carbons used in lead acid batteries. Even further improvements are observed when the improved carbon is used in combination with one or more metal oxide and/or metal sulfate additives.

The lead acid battery comprising the improved carbon or the improved carbon with a metal oxide additive may have one or more of the following properties: cycle life of 1300 cycles or more, 1400 cycles or more, 1500 cycles or more, 1600 cycles or more, 1700 cycles or more, 1800 cycles or more, 1900 cycles or more, or 2000 cycles or more when measured using the VW 17.5% PSoC Test; a dynamic charge acceptance equal to or above about 1.2 A/Ah, equal to or above 1.4 A/Ah, or equal to or above 1.6 A/Ah when measured using the VW DCA at 70% SOC after 510 PSoC Cycles; and a water loss when measured by the Modified SAE-J537 overcharging test is less than 5.0 g/Ah, less than 4.5 g/Ah, less than 4.0 g/Ah, less than 3.5 g/Ah, less than 3.0 g/Ah, or less than 2.5 g/Ah.

The manner in which the improved carbon is added to the lead acid battery is not so limited. For example, the carbon may be added to a separator, to a pasting paper, to an electrolyte, to a negative active material (NAM), to a positive active material (PAM), to a woven, to a nonwoven, to a glass mat, to a gauntlet, or to combinations thereof. The carbon may be added to a porous or nonporous support, substrate, or membrane. A porous support, substrate or membrane may include a polyethylene separator, an AGM separator, a pasting paper, a nonwoven, a woven, a gauntlet, a fibrous mat, a glass mat, or the like. The porous support, substrate or membrane may be microporous. In some preferred embodiments, the improved carbon may be provided to at least one surface of a polyethylene separator like those sold by Daramic LLC or to at least one surface of an AGM separator.

The amount of improved carbon also is not so limited, but may be in the range of from 1 g/m² to 15 g/m2, from 1 g/m² to 14 g/m², from 1 g/m² to 13 g/m2, from 1 g/m² to 12 g/m², from 1 g/m² to 11 g/m², from 1 g/m² to 10 g/m², from 2 g/m² to 10 g/m², from 3 g/m² to 10 g/m², from 4 g/m² to 10 g/m², from 5 g/m² to 10 g/m², from 6 g/m² to 10 g/m², from 7 g/m² to 10 g/m², from 8 g/m² to 10 g/m², or from 9 g/m² to 10 g/m².

The manner in which the metal oxide additive is added to the lead acid battery is also not so limited. For example, the metal oxide may be added to a separator, to a pasting paper, to an electrolyte, to a negative active material (NAM), to a positive active material (PAM), to a woven, to a nonwoven, to a glass mat, to a gauntlet, or to combinations thereof. The metal oxide additive may be added to a porous or nonporous support, substrate, or membrane. A porous support, substrate or membrane may include a polyethylene separator, an AGM separator, a pasting paper, a nonwoven, a woven, a gauntlet, a fibrous mat, a glass mat, or the like. The porous support, substrate or membrane may be microporous. In some preferred embodiments, the metal oxide additive may be provided to at least one surface of a polyethylene separator like those sold by Daramic LLC or to at least one surface of an AGM separator.

The amount of improved metal oxide additive also is not so limited, but may be in the range of from 1 g/m² to 15 g/m2, from 1 g/m² to 14 g/m², from 1 g/m² to 13 g/m2, from 1 g/m² to 12 g/m², from 1 g/m² to 11 g/m², from 1 g/m² to 10 g/m², from 2 g/m² to 10 g/m², from 3 g/m² to 10 g/m², from 4 g/m² to 10 g/m², from 5 g/m² to 10 g/m², from 6 g/m² to 10 g/m², from 7 g/m² to 10 g/m², from 8 g/m² to 10 g/m², or from 9 g/m² to 10 g/m². In some preferred embodiments, the amount of the additive may be from 1 g/m² to 5 g/m² or from 2 g/m² to 5 g/m².

Improved Carbon

The improved carbon described herein may have one or more of the following properties: an oil absorption equal to or greater than 140 ml/100 g or more; a specific surface area of 30 to 3,000 m²/g; a treated surface; and high structure.

In some embodiments, the specific surface area may be 30 m²/g to 3,000 m²/g, 40 m²/g to 3,000 m²/g, 50 m²/g to 3,000 m²/g, 60 m²/g to 3,000 m²/g, 70 m²/g to 3,000 m²/g, 80 m²/g to 3,000 m²/g, 90 m²/g to 3,000 m²/g, 100 m²/g to 3,000 m²/g, 200 m²/g to 3,000 m²/g, 300 m²/g to 3,000 m²/g, 400 m²/g to 3,000 m²/g, 500 m²/g to 3,000 m²/g, 600 m²/g to 3,000 m²/g, 700 m²/g to 3,000 m²/g, 800 m²/g to 3,000 m²/g, 900 m²/g to 3,000 m²/g, 1,000 m²/g to 3,000 m²/g, 1,100 m²/g to 3,000 m²/g, 1,200 m²/g to 3,000 m²/g, 1,300 m²/g to 3,000 m²/g, 1,400 m²/g to 3,000 m²/g, 1,500 m²/g to 3,000 m²/g, 1,600 m²/g to 3,000 m²/g, 1,700 m²/g to 3,000 m²/g, 1,800 m²/g to 3,000 m²/g, 1,900 m²/g to 3,000 m²/g, 2,000 m²/g to 3,000 m²/g, 2,100 m²/g to 3,000 m²/g, 2,200 m²/g to 3,000 m²/g, 2,300 m²/g to 3,000 m²/g, 2,400 m²/g to 3,000 m²/g, 2,500 m²/g to 3,000 m²/g, 2,600 m²/g to 3,000 m²/g, 2,700 m²/g to 3,000 m²/g, 2,800 m²/g to 3,000 m²/g, 2,900 m²/g to 3,000 m²/g. In some preferred embodiments, the carbon may have a specific surface area from 250 m²/g to 1600 m²/g, 300 m²/g to 1600 m²/g, 400 m²/g to 1600 m²/g, 500 m²/g to 1600 m²/g, 600 m²/g to 1600 m²/g, 700 m²/g to 1600 m²/g, 800 m²/g to 1600 m²/g, 900 m²/g to 1600 m²/g, 1,000 m²/g to 1600 m²/g, 1,100 m²/g to 1600 m²/g, 1,200 m²/g to 1600 m²/g, 1,300 m²/g to 1600 m²/g, 1,400 m²/g to 1600 m²/g, 1,500 m²/g to 1600 m²/g.

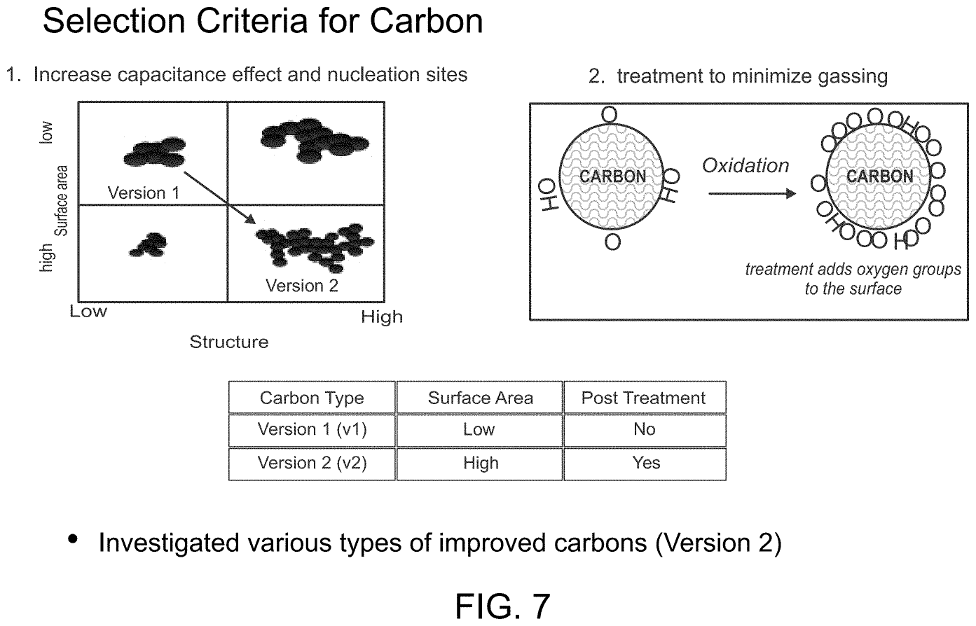

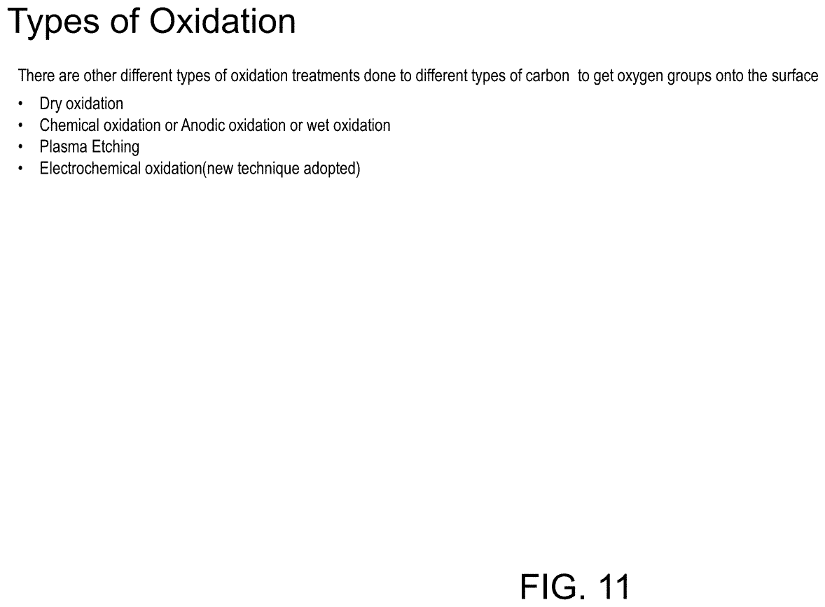

In some particularly preferred embodiments, the carbon has a specific surface area as described hereinabove, and a surface of the carbon has been treated. The surface treatment is not so limited, but may be a surface treatment, such as an oxidation treatment, aimed at introducing oxygen-containing groups onto a surface of the carbon. Examples of some surface treatments are disclosed in FIG. 11. A schematic drawing of a surface-treated carbon is disclosed in FIG. 7. There are other different types of oxidation treatments done to different types of carbon to get oxygen groups onto the surface. Dry oxidation is one. Dry oxidative treatments are normally performed with air, oxygen and CO2 at low or elevated temperatures. As heating decreases the radioactive functional groups on the surface, the carbon becomes less wettable so there is minimizing of gassing. Carbon v2 is produced using this technique.

Chemical oxidation or Anodic oxidation or wet oxidation are another technique. Anodic oxidation is most widely used for treatment of commercial carbon as it is fast, uniform and suited to mass production. Carbon particles act as an anode in a suitable electrolyte bath. A potential is applied to the carbon powder to liberate oxygen on the surface. Typical electrolytes include nitric acid, sulfuric acid, sodium chloride, potassium nitrate, sodium hydroxide, ammonium hydroxide and so on. Plasma Etching is another example of a technique. Plasma is a partially or fully ionized gas containing electrons, radicals, ions and neutral atoms or molecules. The principle of a plasma treatment is the formation of active species in a gas induced by a suitable energy transfer. Typical gases used to create a plasma include air, oxygen, ammonia, nitrogen and argon. Continuous atmospheric plasma oxidation (APO) introduces oxygen functionalities on the surface of carbon in order to improve the interfacial adhesion between carbon particles. After the APO treatment, carbon particles became more hydrophilic due to the introduction of polar oxygen-containing groups on the surface, which also resulted in an increase of particle surface energy. Electrochemical oxidation (new technique adopted) is another technique. It is also similar to chemical oxidation method but it has greater controllability at room temperature. It applies higher current for shorter period of time. This way it has all properties similar to chemical oxidation method but also has an advantage of controlling the surface area.

The improved carbon may have an oil absorption value equal to or greater than 140 ml/100 g and less than or equal to 500 ml/100 g. The oil absorption may be 150 ml/100 g, 160 ml/100 g, 170 ml/100 g, 8 ml/100 g, 190 ml/100 g, 200 ml/100 g, 210 ml/100 g, 220 ml/100 g, 230 ml/100 g, 240 ml/100 g, 250 ml/100 g, 260 ml/100 g, 270 ml/100 g, 280 ml/100 g, 290 ml/100 g, 300 ml/100 g, 310 ml/100 g, 320 ml/100 g, 330 ml/100 g, 340 ml/100 g, 350 ml/100 g, 360 ml/100 g, 370 ml/100 g, 380 ml/100 g, 390 ml/100 g, 400 ml/100 g, 410 ml/100 g, 420 ml/100 g, 430 ml/100 g, 440 ml/100 g, 450 ml/100 g, 460 ml/100 g, 470 ml/100 g, 480 ml/100 g, or 490 ml/100 g.

By providing carbon with higher surface area, it is believed that more sites for chemical reaction are provided. However, hydrogen gas may also form on these spots, and release of hydrogen gas leads to loss of electrolyte. To mitigate electrolyte loss through this mechanism, oxygen-containing groups may be provided on the surface of the carbon. Without wishing to be bound by any particular theory, it is believed that oxygen on the carbon surface reacts with hydrogen to form water, and this mitigates or eliminates electrolyte loss.

In some embodiments, the improved carbon may have a high structure. As understood in the art, high structure means that the carbon black agglomerates form long and branched chains. One example of a high structure carbon is a furnace black carbon.

In some embodiments, the improved carbon may be applied to a substrate alone or in combination with one or more of a binder and an additive.

Additive

The additive is not so limited, but in some preferred embodiments, the additive may comprise, consist of, or consist essentially of a metal oxide, a metal sulfate, or a metal oxide and a metal sulfate.

The metal sulfate is not so limited and may be any sulfate other than a lead sulfate. In some preferred embodiments, the metal sulfate may comprise, consist essentially of, or consist of aluminum sulfate, zinc sulfate, potassium sulfate, sodium sulfate, lithium sulfate, or nickel sulfate.

The metal oxide is not so limited and may be any metal oxide other than lead oxide. In some preferred embodiments, the metal oxide is one that dissolves in battery acid (sulfuric acid) and becomes a sulfate. For example, the metal oxide may be zinc oxide, titanium oxide or titanium dioxide, magnesium oxide, aluminum oxide, calcium oxide, nickel oxide, sodium oxide, copper oxide, potassium oxide, lithium oxide, and silver oxide. In some preferred embodiments, the oxide may be zinc oxide, aluminum oxide, potassium oxide, sodium oxide, lithium oxide, or nickel oxide.

Substrate or Support

The substrate or support on which the improved carbon or the improved carbon and the additive are provided is not so limited. The substrate or support may be porous or nonporous. If the substrate or support is porous, it may be nanoporous, microporous, mesoporous, macroporous, or the like. The substrate or support may be a polyethylene separator, an absorptive glass mat separator, a fibrous mat, a woven, a nonwoven, a gauntlet, a glass mat, or the like.

In some preferred embodiments, the substrate or support on which the improved carbon or the improved carbon and the additive are provided is a battery separator, including a polyethylene battery separator and an absorptive glass mat (AGM) separator. In preferred embodiments, the separators are porous, particularly microporous. However, a separator could be nonporous if it allowed for flow of ions through it. The improved carbon or the improved carbon and the additive may be applied to one or more internal or external surfaces of the substrate or support. They may be applied to one or more internal or external surfaces of a polyethylene battery separator and an absorptive glass mat (AGM) separator. The improved carbon or the improved carbon and the additive may also be applied to two or more internal or external surfaces of the substrate or support. They may also be applied to two or more internal or external surfaces of a polyethylene battery separator and an absorptive glass mat (AGM) separator. Porous separators, particularly porous polyethylene separators have internal surfaces, which are part of the pores that start on an outer surface of the separator and extend into the separator.

In some preferred embodiments, the separator may comprise one or more ribs on one or more surfaces thereof. In some preferred embodiments, the ribs are arranged on at least one surface of the battery separator to create a rib profile. In some preferred embodiments, the rib profile is an acid-mixing rib profile. Examples of acid-mixing rib profiles include, but are not limited to a serrated rib profile or a profile like those on separators sold by Daramic LLC under the name Riptide®. In some preferred embodiments, the improved carbon may be provided on a side of the separator having an acid-mixing rib profile.

Battery

The battery useful with the invention disclosed herein is not so limited, and may include a lead acid battery, wherein the lead acid battery is a flat-plate battery, a flooded lead acid battery, an enhanced flooded lead acid battery, a deep-cycle battery, an absorptive glass mat battery, a tubular battery, an inverter battery, a vehicle battery, a SLI battery, an ISS battery, an automobile battery, a truck battery, a motorcycle battery, an all-terrain vehicle battery, a forklift battery, a golf cart battery, a hybrid-electric vehicle battery, an electric vehicle battery, an e-rickshaw battery, an e-trike battery, or an e-bike battery.

Generally, the lead acid battery may comprise at least a negative active material (NAM), a positive active material (PAM), a separator, and an electrolyte. In some preferred embodiments, the improved carbon described herein is provided in direct contact with the negative active material (NAM).

### EXAMPLES

### Control Cells

The Control cells used a typical commercially available separator without incorporating a carbon. These separators are labeled as “standard SLI” and “RipTide® C” in the Figures.

### Acetylene Black Carbon/Carbon v1 Cells

The Acetylene Black cells (labeled “Standard SLI+Carbon v1” and “RipTide® C+Carbon v1” in the Figures) used the same separator as the Control Cells with the exception of having a separator incorporating an acetylene black coating of approximately 10 μm thick and a coating weight distribution of approximately 0.35 mg/cm² (3.5 g/m²).

The acetylene black coating had approximately 1% by weight to approximately 5% by weight of an acrylic binder.

### Furnace Black Carbon/Carbon v2 Cells

The Furnace Black cells (labeled “RipTide® C+carbon v2” in the Figures) used the same separators as the Control Cells and Acetylene Black Cells, and were the same as the Acetylene Black Cells with the exception of having a separator incorporating a furnace black in the coating. The furnace black (carbon v2 may be treated using a dry oxidation process as described in the Figures. The furnace black (carbon v2) may have a specific surface area of about 1,100 m²/g. The acetylene black (carbon v1) is not treated with an oxidation process and has a specific surface area less than 200 m²/g.

### Furnace Black Carbon/Carbon v2+Zinc Oxide Cells

The Furnace Black Carbon+Zinc Oxide cells (labelled Riptide® C+Carbon v2+Additive in the Figures) used the same separators as the other Cells. The coating was the same as in the Furnace Black Cells except that zinc oxide was added in an amount of 3.0 g/m².

For measuring the charge acceptance, all the battery cells were discharged for 20 hours and then charged. During charging the dynamic charge acceptance (A/Ah) was measured at the 1^{st} second of charging and at the 60^{th} second of charging and at multiple states of charge (%). Each cell tested was a 2.5 Ah AMCO cell with a Pb grid containing 2.5% antimony (Sb).

Cells were tested using the VW 17.5% Partial State of Charge (PSOC) Test. This is the test used by the Consortium of Battery Innovation (CBI)

Cells were also tested using VW Dynamic Charge Acceptance (DCA) at 70% state of charge (SOC) (after 510 PSOC cycles).

Cells were also tested using Modified SAE-J537 with the modification including a time of 96 hours at 2.5V and 25° C. due to tool limitations.

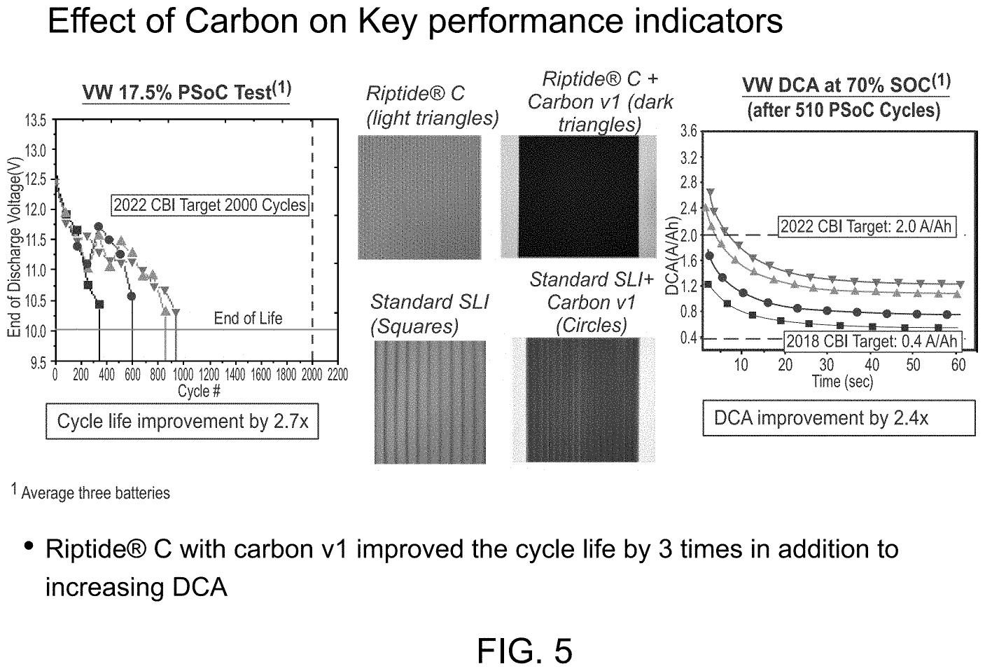

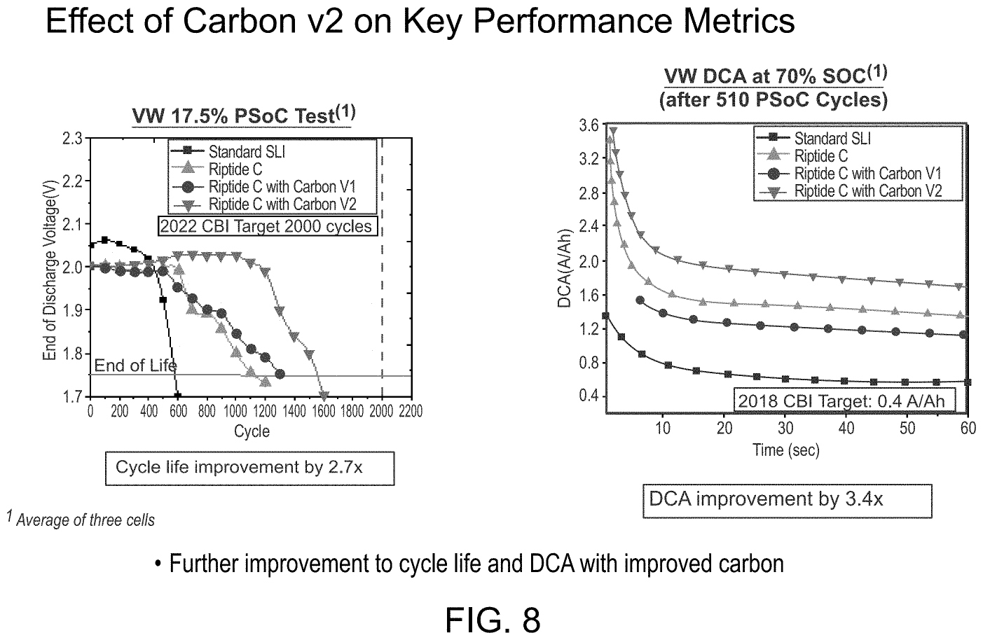

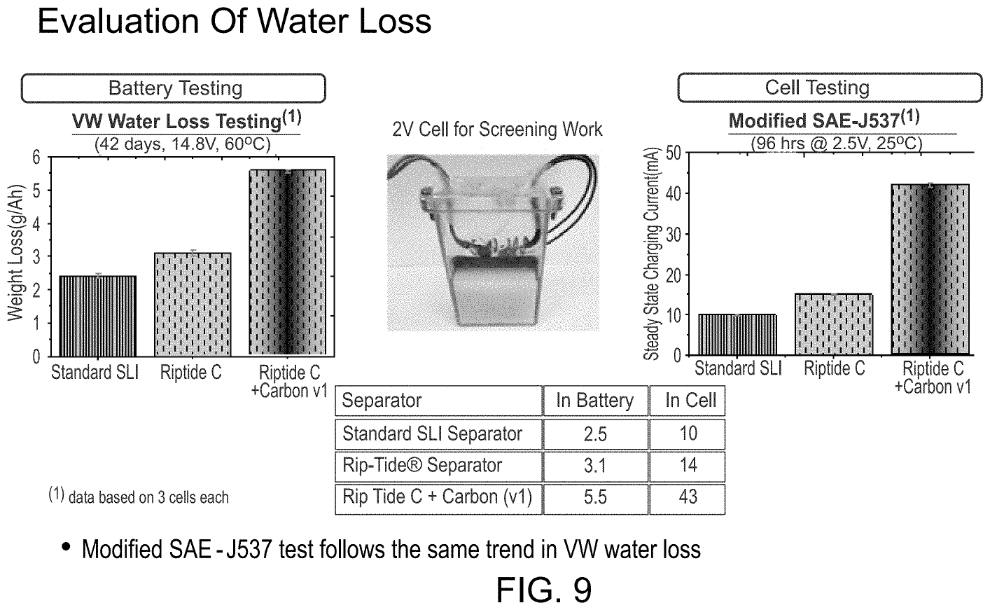

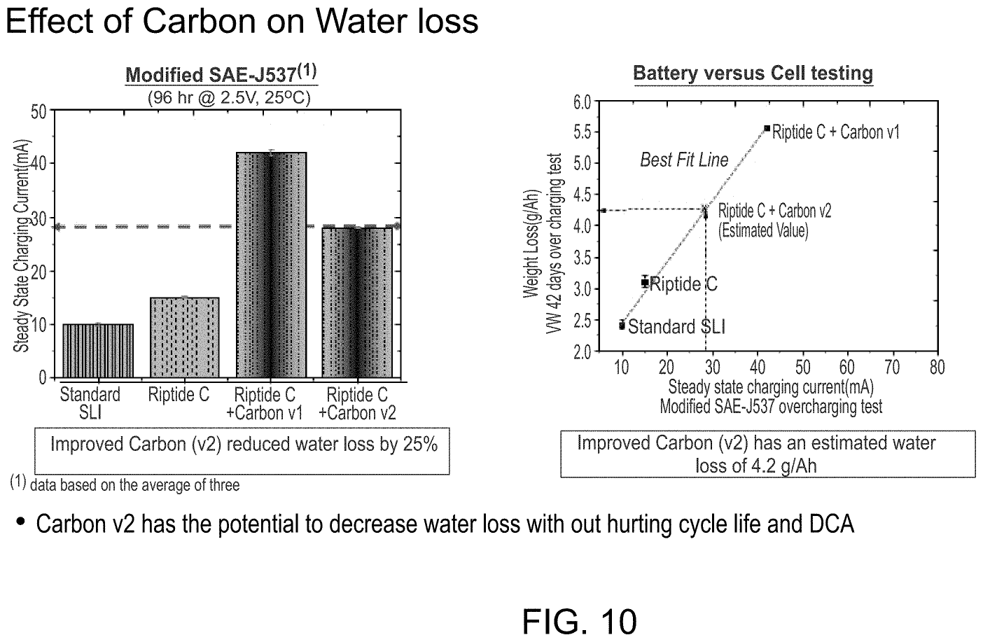

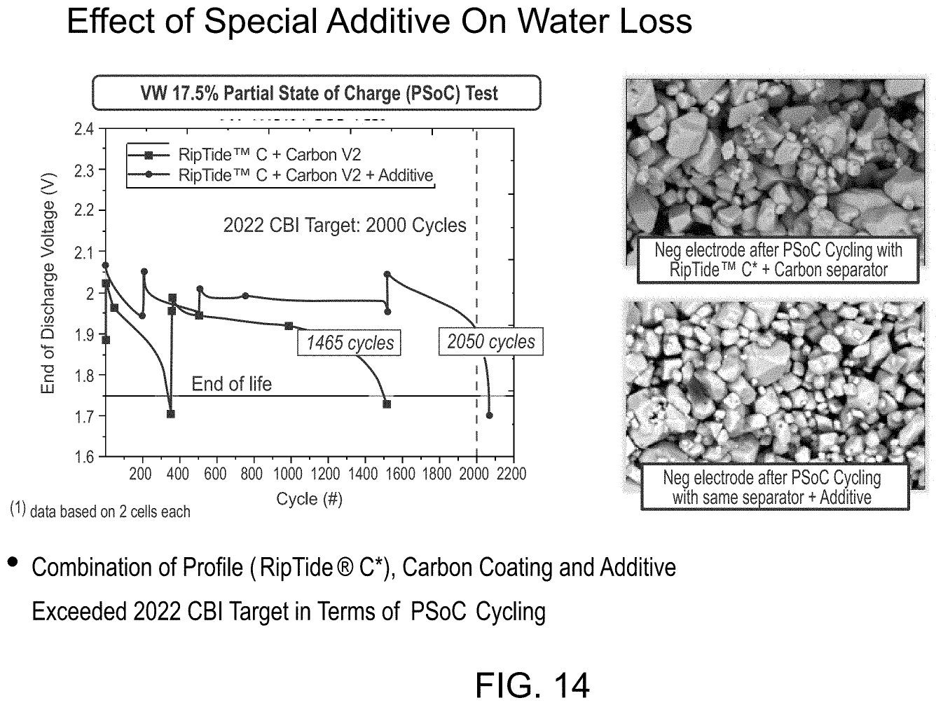

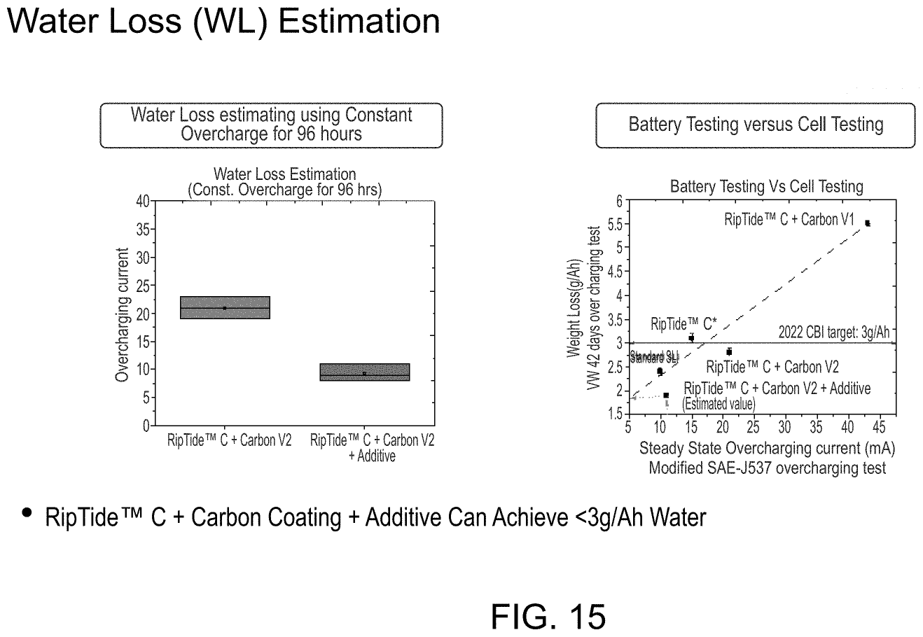

Results are shown in FIGS. 5, 8-10, 14, and 15. With respect to carbon v2, which is an example of a novel carbon as described herein, FIG. 8 shows that using carbon v2+Riptide® C results in a cycle life improvement of ×2.6 over the standard SLI with no carbon. The carbon v2+Riptide® C also exhibits a cycle life improvement of about 300 cycles or more than 25% compared to carbon v1+Riptide® C. Dynamic Charge Acceptance (DCA) is also improved more than about 25%. FIGS. 9 and 10 show that carbon v2+Riptide® C exhibits a decrease in water loss of about 25% compared to carbon v1+Riptide® C. With regard to the use of carbon v2 and a metal oxide additive, FIG. 14 shows that carbon v2+Riptide® C+additive (where the additive is zinc oxide) has an increased cycle life of about 585 cycles compared to carbon v2+Riptide® C. Further, FIG. 15 shows that water loss is reduced by about 50% when the additive zinc oxide is used. Thus, the improved carbon described herein is shown to result in better performance than prior used carbon. The addition of a metal oxide additive further enhances this performance.

The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Additionally, the invention illustratively disclosed herein suitably may be practiced in the absence of any element which is not specifically disclosed herein.

1.-33. (canceled)

34. A lead acid battery comprising carbon, wherein the carbon has one or more of the following properties:
an oil absorption equal to or greater than 140 ml/100 g and equal to or less than 500 ml/100 g;
a specific surface area of 30 to 3,000 m²/g;
a treated surface; and
high structure.

35. The lead acid battery of claim 34, wherein the carbon has a specific surface area from 50 m²/g to 1,600 m²/g

36. The lead acid battery of claim 35, wherein the carbon has a specific surface area from 800 m²/g to 1600 m²/g.

37. The lead acid battery of claim 34, wherein the carbon has a treated surface.

38. The lead acid battery of claim 37, wherein the carbon has oxygen-containing groups on its surface.

39. The lead acid battery of claim 34, wherein the carbon is a furnace black carbon.

40. The lead acid battery of claim 34, wherein the carbon has high structure.

41. The lead acid battery of claim 34, wherein the carbon has an oil absorption equal to or greater than 140 ml/100 g and equal to or less than 500 ml/100 g.

42. The lead acid battery of claim 34, wherein the carbon is provided on an internal and/or external surface of a substrate.

43. The lead acid battery of claim 42, wherein the substrate is a porous membrane.

44. The lead acid battery of claim 43, wherein the porous membrane is a polyethylene separator, a woven, a non-woven, a pasting paper, a fibrous mat, an absorptive glass mat (AGM), or combinations thereof.

45. The lead acid battery of claim 42, wherein the carbon is provided on the substrate surface in an amount of 5 to 20 grams per square-meter of substrate surface.

46. The lead acid battery of claim 42, wherein carbon and a metal oxide or metal sulfate are provided on the substrate.

47. The lead acid battery of claim 46, wherein the metal oxide is one or more of the following: zinc oxide, titanium oxide or titanium dioxide, magnesium oxide, aluminum oxide, calcium oxide, nickel oxide, sodium oxide, lithium oxide, potassium oxide, copper oxide, silver oxide, or combinations thereof.

48. The lead acid battery of claim 46, wherein the metal oxide or metal sulfate is provided on the substrate in an amount of 1 to 10 grams per square-meter of substrate.

49. The lead acid battery of claim 48, wherein the metal oxide or metal sulfate is provided in an amount of 2 to 5 grams per square-meter of substrate.

50. The lead acid battery of claim 34, wherein the carbon is in direct contact with a negative active material (NAM), a positive active material (PAM), or both a NAM and a PAM.

51. The lead acid battery of claim 34, wherein the battery exhibits one or more of the following properties:
cycle life of 1300 cycles or more, 1400 cycles or more, 1500 cycles or more, 1600 cycles or more, 1700 cycles or more, 1800 cycles or more, 1900 cycles or more, or 2000 cycles or more when measured using the VW 17.5% PSoC Test;
a dynamic charge acceptance equal to or above about 1.2 A/Ah, equal to or above 1.4 A/Ah, or equal to or above 1.6 A/Ah when measured using the VW DCA at 70% SOC after 510 PSoC Cycles; and
a water loss when measured by the Modified SAE-J537 overcharging test is less than 5.0 g/Ah, less than 4.5 g/Ah, less than 4.0 g/Ah, less than 3.5 g/Ah, less than 3.0 g/Ah, or less than 2.5 g/Ah.

52. The lead acid battery of claim 34, wherein the lead acid battery is a flat-plate battery, a flooded lead acid battery, an enhanced flooded lead acid battery, a deep-cycle battery, an absorptive glass mat battery, a tubular battery, an inverter battery, a vehicle battery, a SLI battery, an ISS battery, an automobile battery, a truck battery, a motorcycle battery, an all-terrain vehicle battery, a forklift battery, a golf cart battery, a hybrid-electric vehicle battery, an electric vehicle battery, an e-rickshaw battery, an e-trike battery, or an e-bike battery.

53. A battery separator comprising a porous substrate and a carbon-containing coating on an internal and/or external surface of the porous substrate, wherein the carbon of the carbon-containing coating has one or more of the following properties:
an oil absorption equal to or greater than 140 ml/100 g and equal to or less than 500 ml/100 g;
a specific surface area of 30 to 3,000 m²/g;
a treated surface; and
high structure.

54. The separator of claim 53, wherein the carbon has a specific surface area from 50 m²/g to 1,600 m²/g

55. The separator of claim 54, wherein the carbon has a specific surface area from 800 m²/g to 1600 m²/g.

56. The separator of claim 53, wherein the carbon has a treated surface.

57. The separator of claim 56, wherein the carbon has oxygen-containing groups on its surface.

58. The separator of claim 53, wherein the carbon is a furnace black carbon.

59. The separator of claim 53, wherein the carbon has high structure.

60. The separator of claim 53, wherein the carbon has an oil absorption equal to or greater than 140 ml/100 g and equal to or less than 500 ml/100 g

61. The separator of claim 53, wherein the carbon is provided on the substrate surface in an amount of 5 to 20 grams per square-meter of substrate surface.

62. The separator of claim 53, wherein a metal oxide and/or metal sulfate and carbon are provided on an internal and/or external surface of the substrate.

63. The separator of claim 62, wherein the metal oxide is one or more of the following at least one of zinc oxide, titanium oxide or titanium dioxide, magnesium oxide, aluminum oxide, calcium oxide, nickel oxide, sodium oxide, copper oxide, potassium oxide, lithium oxide and silver oxide.

64. The separator of claim 62, wherein the metal oxide and/or metal sulfate is provided on the substrate surface in an amount of 1 to 10 grams per square-meter of substrate surface.

65. The separator of claim 62, wherein the metal oxide and/or metal sulfate is provided on the substrate surface in an amount of 2 to 5 grams per square-meter of substrate surface.

66. The separator of claim 53, wherein the porous substrate is a polyethylene separator, an absorptive glass mat separator, a pasting paper, a woven, a nonwoven, a glass mat, a fibrous mat.

67. The separator of claim 53, wherein the porous substrate has an acid-mixing rib profile on at least one surface thereof.

68. The separator of claim 67, wherein the carbon-containing coating is provided on a side of the porous substrate that has an acid-mixing rib profile.
